(19) United States
(12) Patent Application Publication
(10) Pub. No.: US 2021/0066722 A1
(43) Pub. Date: Mar. 4, 2021

(54) Method And System For Carbon Compositions As Conductive Additives For Silicon Dominant Anodes

(71) Applicant: Enevate Corporation, Irvine, CA (US)

(72) Inventors: Younes Ansari, Irvine, CA (US); Rahul Kamath, Mission Viejo, CA (US); Benjamin Park, Mission Viejo, CA (US); Jill Renee Pestana, Long Beach, CA (US)

(21) Appl. No.: 16/557,765

(22) Filed: Aug. 30, 2019

(51) Int. Cl. H01M 4/62; H01M 4/134; H01M 4/1395; H01M 4/38; H01M 4/04; H01M 10/0525; H01M 10/058

(52) U.S. Cl. CPC H01M 4/625; H01M 4/134; H01M 4/1395; H01M 2004/027; H01M 4/0404; H01M 10/0525; H01M 10/058; H01M 4/386

(57) ABSTRACT

Systems and methods for carbon compositions as conductive additives for silicon dominant anodes may include a cathode, an electrolyte, and an anode active material. The active material may include 0D conductive carbon particles with nanoscale structure in three dimensions, 1D conductive carbon particles with nanoscale structure in two dimensions, and 2D conductive carbon particles with nanoscale structure in one dimension. The carbon particles may be between 1% and 40% of the active material. The anode active material may comprise between 20% to 95% silicon or between 50% to 95% silicon. The 0D conductive carbon particles may have a diameter of 50 nm or less. The 1D conductive carbon particles may comprise nanotubes, nanofibers, and/or vapor grown fibers. The 1D conductive carbon particles may have an aspect ratio of 20 or greater. The 2D conductive carbon particles may have a length in each of two dimensions between 1 and 30 μm.

### CROSS-REFERENCE TO RELATED APPLICATIONS/INCORPORATION BY REFERENCE

N/A

### FIELD

Aspects of the present disclosure relate to energy generation and storage. More specifically, certain embodiments of the disclosure relate to a method and system for carbon compositions as conductive additives for silicon dominant anodes.

### BACKGROUND

Conventional approaches for battery anodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for carbon compositions as conductive additives for silicon dominant anodes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery with an ultra-high voltage cobalt-free cathode, in accordance with an example embodiment of the disclosure.

FIG. 2 illustrates a graphic representation of a ternary carbon composite, in accordance with an example embodiment of the disclosure.

FIG. 3 is a flow diagram of a process for forming a ternary carbon composite in a silicon anode, in accordance with an example embodiment of the disclosure.

FIG. 4 is a plot of galvanostatic cycling performance of standard and binary conductive carbon additive anodes, in accordance with an example embodiment of the disclosure.

FIG. 5 is a plot of galvanostatic cycling performance of standard and ternary conductive carbon additive anodes, in accordance with an example embodiment of the disclosure.

FIG. 6 is a bar chart of electrical conductivities of anodes with various carbon additives, in accordance with an example embodiment of the disclosure.

### DETAILED DESCRIPTION OF THE INVENTION

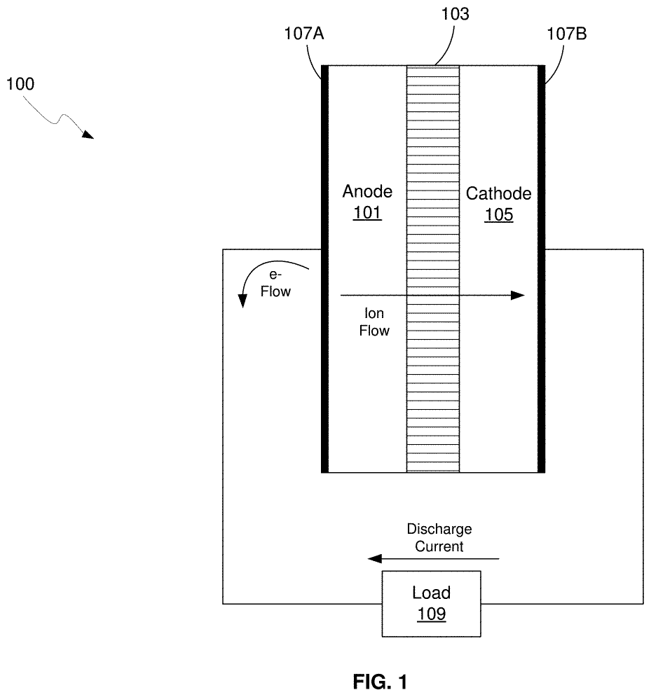

FIG. 1 is a diagram of a battery, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 1078, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 107 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (3579 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

A solution to enhance the electrical conductivity of Li-ion battery anodes and cathodes is to add conductive carbon additives. Two primary benefits of adding conductive additives to anodes and cathodes are improved particle-to-particle conductivity and improved particle-to-current-collector conductivity. These additives maintain conductive pathways for electrons, minimizing capacity loss in electrode active materials and, thus, enhancing the overall performance of Li-ion batteries. Because of the large volume changes of silicon-dominant anodes, maintaining conductive pathways throughout volume changes remains challenging. Typically, Li-ion batteries employ carbon additives with rigid structures, which do not flex, to accommodate the volume changes. In an example embodiment of this disclosure, high-performance anode materials are prepared by adding a blend of conducting additives with different morphologies to the anode, which accommodate the volume changes of electrodes during cycling by utilizing a “cushion effect”.

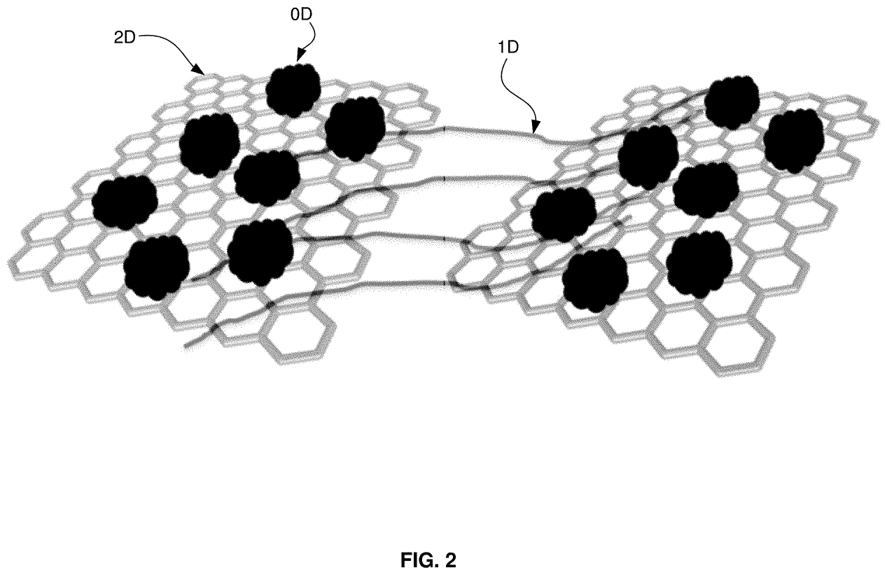

FIG. 2 illustrates a graphic representation of a ternary carbon composite, in accordance with an example embodiment of the disclosure. The various material types are labeled 0D, 1D, and 2D to indicate the number of dimensions in which the structures are not confined to nanoscale dimensions, i.e., the number of dimensions in which the structure extends beyond nanoscale distances. For example, a planar structure, such as graphene is confined in one dimension, e.g., one atomic layer, but extends larger distances in two dimensions, while a carbon nanotube is essentially linear, being confined in two dimensions but extends in one dimension well beyond the dimension of the structure on the two nanoscale dimensions, with an aspect ratio of 20 or greater, for example. A 0D structure is confined to small size in all three dimensions, i.e., very small particles such as carbon black, akin to quantum dots in quantum structures, and may comprise substantially spherical shapes.

The fibrous VGCF (1D) in conjunction with Super P (0D) and graphene platelets (2D) form electrical pathways that can stretch, offering continuous electrical contact with silicon and/or carbon particles during volume changes in the electrode. The specific mix of carbons allows for the carbons to interact with each other and maintain the conductive network easier. For example, one explanation may be that the 0D materials provide many moving connection points between the 1D and 2D materials. The 2D structures can slide against other 2D structures and the 1D materials can provide “bridges” between different conductive zones.

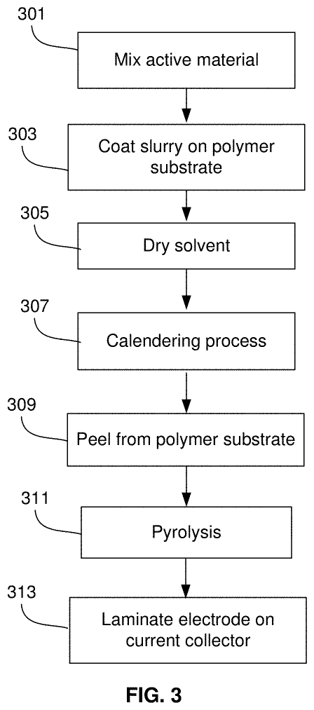

FIG. 3 is a flow diagram of a process for forming a ternary carbon composite in a silicon anode, in accordance with an example embodiment of the disclosure. While conventional processes to fabricate composite electrodes physically mix the active material, conductive additive, and binder together, and coat it directly on a current collector, this process employs a high-temperature pyrolysis process coupled with a lamination process.

The raw electrode active material is mixed in step 301. In the mixing process, the active material may be mixed, e.g., a binder/resin (such as PI, PAI), solvent, and conductive carbon. For example, graphene/VGCF (1:1 by weight) may be dispersed in NMP under sonication for, e.g., 1 hour followed by the addition of Super P (1:1:1 with VGCF and graphene) and additional sonication for, e.g., 1 hour. Silicon powder with a 10-20 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

In step 303, the slurry may be coated on a substrate. In this step, the slurry may be coated onto a Polyester, polyethylene terephthalate (PET), or Mylar film at a loading of, e.g., 3.63 mg/cm² and then in step 305 undergo drying to an anode coupon with high Si content and less than 15% residual solvent content. This may be followed by an optional calendering process in step 307, where a series of hard pressure rollers may be used to finish the film/substrate into a smoothed and denser sheet of material.

In step 309, the green film may then be removed from the PET, where the active material may be peeled off the polymer substrate, the peeling process being optional for a polypropylene (PP) substrate, since PP can leave ˜2% char residue upon pyrolysis. The peeling may be followed by a pyrolysis step 311 where the material may be heated to >900 C but less than 1250 C for 1-3 hours, cut into sheets, and vacuum dried using a two-stage process (120° C. for 15h, 220° C. for 5h). The dry film may be thermally treated at, e.g., 1175° C. to convert the polymer matrix into carbon.

In step 313, the electrode material may be laminated on a current collector. For example, a 15 μm thick copper foil may be coated with polyamide-imide with a nominal loading of, e.g., 0.45 mg/cm² (applied as a 6 wt % varnish in NMP and dried for, e.g., 16 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 50 seconds at 300° C. and 4000 psi, thereby forming the finished silicon-composite electrode.

The process described above is one example process that represents a composite with fabrication steps including pyrolysis and lamination. Another example scenario comprises a direct coating process in which an anode slurry is directly coated on a copper foil using a binder such as CMC, SBR, Sodium Alginate, PAI, PI and mixtures and combinations thereof. The process in this example comprises: direct coat active material on a current collector, dry, calender, heat treatment.

In a direct coating process, an anode slurry is coated on a current collector with <15% residual solvent followed by calendaring process for densification followed by pyrolysis (˜500-800 C) such that carbon precursors are partially or completely converted into glassy carbon. Pyrolysis can be done either in roll form or after punching. If done in roll form, the punching is done after the pyrolysis process.

In another example of a direct coating process, an anode slurry may be coated on a current collector with <15% residual solvent followed by a calendaring process for densification followed by removal of residual solvent.

In an example scenario, the carbon material or carbon particles may comprise between 1 and 40% of the anode composition, with between 60% and 99% silicon. The 0D particles may have a largest diameter of 50 nm, and may comprise a porous and high surface area carbon material such as SuperP, Ketjen Black, and other such materials. The 1D particles may have an aspect ratio of at least 20 and may comprise a tubular or fiber-like carbon source with nanoscale structures in two-dimensions such as carbon nanotubes, carbon nanofibers (CNF), and vapor grown carbon fibers (VGCP), for example.

The 2D carbon structures may have an average dimension in the micron scale in each of the two non-nanoscale dimensions, between 1 and 30 μm, for example. Furthermore, the active material may comprise 3D carbon, such as graphite, where the material is not limited to nanoscale in any one dimension. Although the anode forming process above illustrates carbon incorporated into silicon, the disclosure is not so limited, as other anode materials and combinations are possible using materials such as lithium, sodium, potassium, silicon, and mixtures and combinations thereof.

In another example scenario, the anode active material fabricated with the carbon additive described above may comprise 20 to 95% silicon and in yet another example scenario may comprise 50 to 95% silicon. The ternary carbon mixture may be selected from 0D, 1D, and 2D/3D carbon, where the 0D carbon comprises such as KB, SP, or doped porous carbon nanoparticles, the 1D carbon comprises VGCF, CNF, or carbon nano-rods, and the 2D/3D carbon comprises graphene or graphite, for example. Alternatively, the carbon mixture may be selected from amorphous carbons (0D and 1D) and crystalline carbons (1D-3D), and combinations thereof.

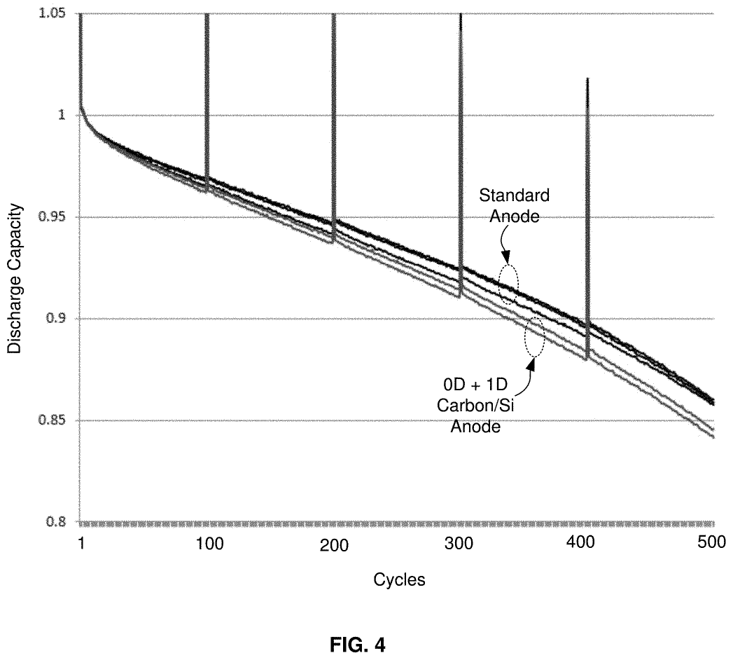

FIG. 4 is a plot of galvanostatic cycling performance of standard and binary conductive carbon additive anodes, in accordance with an example embodiment of the disclosure. The plot compares the cycling performance of a control anode with a non-standard anode where 5% of the single conductive carbon portion from the control anode is replaced with a mixture of a 0D carbon (SP) and 1D carbon (carbon fiber) with a ratio of 1:1. The result shows that addition of the binary carbon mixture impairs the performance of the control anode, as the discharge capacity is lower with the binary carbon additive as the number of cycles increases.

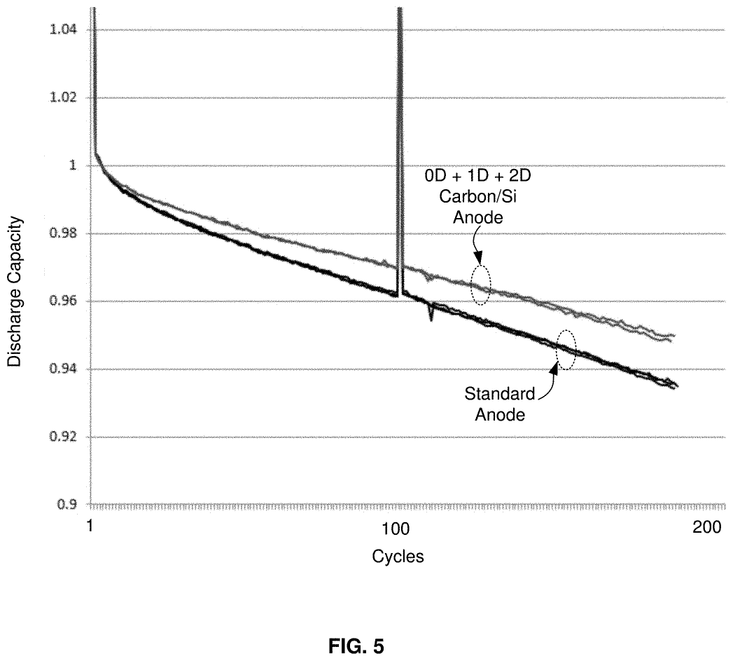

FIG. 5 is a plot of galvanostatic cycling performance of standard and ternary conductive carbon additive anodes, in accordance with an example embodiment of the disclosure. The plot compares the cycling performance of a control anode with a non-standard anode where 5% of the standard anode carbon is replaced with a mixture of a 0D carbon (SP), 1D carbon (carbon fiber), and 2D carbon (graphene) with a ratio of 1:1:1. The result shows that the addition of the ternary carbon mixture has improved performance compared to the control anode even after only a few cycles.

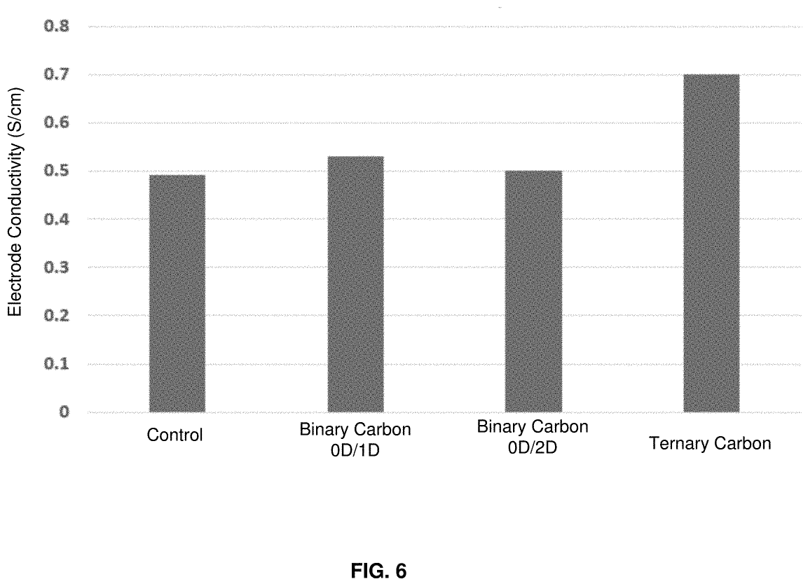

FIG. 6 is a bar chart of electrical conductivities of anodes with various carbon additives, in accordance with an example embodiment of the disclosure. The bar chart compares the electronic conductivities of anodes with various carbon additives, as indicated by the results for Control (standard), Binary Carbon (0D/1D), Binary Carbon (0D/2D) and Ternary Carbon (0D+1D+2D). The ternary carbon composition electrode has the highest conductivity. Therefore, the ternary carbon mixture shows improved performance in Si-containing anodes with decreased cell resistance, improved cyclability, and increased robustness of the anode.

In an example embodiment of the disclosure, a method and system is described for a battery with carbon compositions as conductive additives for silicon dominant anodes. The battery may comprise a cathode, an electrolyte, and an anode comprising an active material. The active material may comprise 0D conductive carbon particles with nanoscale structure in three dimensions, 1D conductive carbon particles with nanoscale structure in two dimensions, and planar 2D conductive carbon particles with nanoscale structure in one dimension. The 0D, 1D, and 2D particles may comprise between 1% and 40% of the active material. The anode active material may comprise between 20% to 95% silicon. The anode active material may comprise between 50% to 95% silicon. The 0D conductive carbon particles may have a diameter of 50 nm or less. The 1D conductive carbon particles may comprise carbon nanotubes, carbon nanofibers (CNF), and/or vapor grown carbon fibers (VGCP). The 1D conductive carbon particles may have an aspect ratio of 20 or greater. The 2D conductive carbon particles may have a length in each of two dimensions between 1 and 30 μm. The battery may comprise a lithium ion battery, and the electrolyte may comprise a liquid, solid, or gel.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A battery, the battery comprising:
a cathode, an electrolyte, and an anode comprising an active material, the active material comprising:
0D conductive carbon particles with nanoscale structure in three dimensions;
1D conductive carbon particles with nanoscale structure in two dimensions; and
planar 2D conductive carbon particles with nanoscale structure in one dimension.

2. The battery according to claim 1, wherein the 0D, 1D, and 2D particles comprise between 1% and 40% of the active material.

3. The battery according to claim 1, wherein the anode active material comprises between 20% to 95% silicon.

4. The battery according to claim 1, wherein the anode active material comprises between 50% to 95% silicon.

5. The battery according to claim 1, wherein the 0D conductive carbon particles have a diameter of 50 nm or less.

6. The battery according to claim 1, wherein the 1D conductive carbon particles comprise carbon nanotubes, carbon nanofibers (CNF), and/or vapor grown carbon fibers (VGCP).

7. The battery according to claim 1, wherein the 1D conductive carbon particles have an aspect ratio of 20 or greater.

8. The battery according to claim 1, wherein the 2D conductive carbon particles have a length in each of two dimensions between 1 and 30 μm.

9. The battery according to claim 1, wherein the battery comprises a lithium ion battery.

10. The battery according to claim 1, wherein the electrolyte comprises a liquid, solid, or gel.

11. A method of forming a battery, the method comprising:
forming a battery comprising an anode, a cathode, and an electrolyte, the anode comprising an active material that comprises:
0D conductive carbon particles with nanoscale structure in three dimensions;
1D conductive carbon particles with nanoscale structure in two dimensions; and
planar 2D conductive carbon particles with nanoscale structure in one dimension.

12. The method according to claim 11, wherein the 0D, 1D, and 2D particles comprise between 1% and 40% of the active material.

13. The method according to claim 11, wherein the anode active material comprises between 20% to 95% silicon.

14. The method according to claim 11, wherein the anode active material comprises between 50% to 95% silicon.

15. The method according to claim 11, wherein the 0D conductive carbon particles have a diameter of 50 nm or less.

16. The method according to claim 11, wherein the 1D conductive carbon particles comprise carbon nanotubes, carbon nanofibers (CNF), and/or vapor grown carbon fibers (VGCP).

17. The method according to claim 11, wherein the 1D conductive carbon particles have an aspect ratio of 20 or greater.

18. The method according to claim 11, wherein the 2D conductive carbon particles have a length in each of two dimensions between 1 and 30 μm.

19. The method according to claim 11, wherein the battery comprises a lithium ion battery and the electrolyte comprises a liquid, solid, or gel.

20. The method according to claim 11, comprising forming the anode using a peeling and laminating process of the active material on a current collector.

21. The method according to claim 11, comprising forming the anode using a direct coating process of the active material on a current collector

22. A battery, the battery comprising:
a battery comprising a cathode, an electrolyte, and an anode comprising an active material, the active material comprising:
silicon;
0D conductive carbon particles with nanoscale structure in three dimensions;
1D conductive carbon particles with nanoscale structure in two dimensions; and
planar 2D conductive carbon particles with nanoscale structure in one dimension.
